(19) United States
(12) Patent Application Publication
(10) Pub. No.: US 2025/0276746 A1
(43) Pub. Date: Sep. 4, 2025

(54) SEMI-TRACTOR ROLLOVER PREVENTION DEVICE

(71) Applicant: Axicle, Inc., Inglewood, CA (US)

(72) Inventors: Stephen Leo Krug, Inglewood, CA (US); Kyle Walker, Alamo Heights, TX (US)

(21) Appl. No.: 19/069,213

(22) Filed: Mar. 3, 2025

Related U.S. Application Data
(60) Provisional application No. 63/561,220, filed on Mar. 4, 2024.

(51) Int. Cl. B62D 49/08; B62D 53/08

(52) U.S. Cl. CPC B62D 49/08; B62D 53/08

(57) ABSTRACT

A rollover prevention device couples a semi-trailer to a semi-tractor. The rollover prevention device comprises a top plate configured to be coupled to the semi-trailer and a bottom plate configured to be coupled to the semi-tractor. One or more frangible fasteners couple the top plate to the bottom plate. The rollover prevention device includes a controller coupled to one or more sensors, with the controller configured to determine a roll angle and a roll rate of the rollover prevention device. In response to determining the roll angle and/or the roll rate satisfy a rollover condition, the controller transmits a control signal to separable fasteners, which separate in response to the control signal allowing the top plate to detach from the bottom plate.

### CROSS-REFERENCE TO RELATED APPLICATIONS

This application claims the benefit of U.S. Provisional Application No. 63/561,220, filed Mar. 4, 2024, which is incorporated by reference in its entirety.

### BACKGROUND

A semi-trailer is attached to a semi-tractor through a fifth wheel connection. As the semi-tractor moves, the semi-trailer also moves. However, the center of gravity of a semi-tractor is significantly lower than the center of gravity of a semi-trailer. Therefore, a semi-tractor without an attached trailer is more resistant to rollovers than a semi-tractor with an attached trailer. Because of this, most rollovers of a semi-tractor are caused when a semi-trailer is attached to the semi-tractor. Often, a rollover of a semi-tractor with an attached semi-trailer is caused by the torque that the semi-trailer applies to the semi-tractor the fifth wheel connection during high-speed cornering, high winds, or while driving on a highly inclined surface.

About half of all semi-tractor drivers that die in on-road accidents die when the semi-tractor rolls over. Existing solutions such as antilock brakes and electronic stability control have not significantly reduced the number of rollover accidents that occur each year.

### BRIEF DESCRIPTION OF THE DRAWINGS

FIG. 1 is a perspective view of a location on a semi-tractor where a fifth wheel is typically installed, in accordance with one or more embodiments.

FIG. 2 is a top perspective view of an example of a rollover prevention device with a top plate installed, in accordance with one or more embodiments.

FIG. 3 is a side cross-section view of an example of a rollover prevention device with a top plate installed, in accordance with one or more embodiments.

FIG. 4 is a top perspective view of a rollover prevention device without a top plate installed, in accordance with one or more embodiments.

FIG. 5 is a block diagram of an architecture of a controller of a rollover prevention device, in accordance with one or more embodiments.

FIG. 6 is a side cross-section view of an example rollover prevention device without a top plate installed, in accordance with one or more embodiments.

FIG. 7 illustrates an example of a top plate of the rollover prevention device pivoting off of the mounting cones and bottom plate of the rollover prevention device, in accordance with one or more embodiments.

FIG. 8 illustrates one embodiment of assembling pillow blocks of the rollover prevention device onto mounting cones of the rollover prevention device, in accordance with one or more embodiments.

FIG. 9 is a top perspective view of an alternative embodiment of a pillow block and a bottom plate of a rollover prevention device.

FIG. 10 is a side cross-sectional view of the alternative embodiment of the pillow block and the bottom plate of a rollover prevention device shown by FIG. 9.

FIG. 11 is an overhead view of one embodiment of a repositionable fifth wheel connector.

FIG. 12 is an overhead view of an alternative embodiment of a repositionable fifth wheel connector.

FIGS. 13A and 13B are perspective views of another embodiment of a repositionable fifth wheel connector.

FIG. 14 is a flowchart of one embodiment of a method for determining whether to transmit a control signal to frangible fasteners of a rollover prevention device.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. Wherever practicable, similar or like reference numbers may be used in the figures and may indicate similar or like functionality.

The disclosed embodiments include a rollover prevention device configured to couple a semi-trailer to a semi-tractor. The rollover prevention device includes a top plate and a bottom plate. The top plate is configured to be coupled to a semi-trailer, and the bottom plate is configured to be coupled to a portion of the semi-tractor. One or more frangible fasteners couple the top plate to the bottom plate. In various embodiments, one or more secondary securing mechanisms further couple the top plate to the bottom plate.

The rollover prevention device also includes one or more sensors communicatively coupled to a controller. In various embodiments, the sensors monitor one or more of: inertia, force, linear speed, rotational speed, vibration, or GPS signals. Based on data monitored by the sensors, the controller generates an estimate of the semi-tractor or the semi-trailer's attitude, heading, and/or global position. The attitude includes velocity, roll, pitch, yaw, angle estimates, rotational rates, rotational accelerations, and linear accelerations. The controller also includes, or is coupled to, an inertial measurement unit (IMU) comprising one or more gyroscopes or one or more multi-axis accelerometers. One or more of the sensors capture data capable of determining a roll angle of the rollover prevention device and a roll rate of the rollover prevention device.

In various embodiments, the controller and IMU, as well as one or more other systems, are included in a rollover prevention device and are positioned proximate to a fifth-wheel that connects the semi-trailer to the semi-tractor. However, in other embodiments the controller is proximate to the fifth-wheel connection, while one or more sensors communicatively coupled to the controller are in different positions of the semi-tractor or the semi-trailer. Based on data captured by one or more sensors, the controller determines whether a roll angle, a roll rate, and/or other conditions of the rollover prevention device satisfy a rollover condition. An example rollover condition comprises a roll angle of the rollover prevention device being within a threshold amount of a threshold roll angle. Another example rollover condition comprises a roll rate of the rollover prevention device equaling or exceeding a threshold roll rate. As another example, the rollover condition comprises a combination of a threshold roll angle and a threshold roll rate meeting predefined criteria. For example, the controller may perform a lookup of a determined roll angle and determined roll rate in a lookup table that maps these conditions to an output decision indicative of whether or not the rollover condition is met. In response to determining the roll angle and/or the roll rate satisfies a rollover condition, the controller transmits a control signal to the one or more separable (e.g., frangible) fasteners of the rollover prevention device to cause the fasteners to separate (e.g., by detonating frangible fasteners), thereby separating the semi-tractor from the semi-trailer. In other embodiments, the controller determines one or more rollover conditions based on alternative data obtained by the controller, such as a height of a center of gravity of a semi-trailer coupled to the rollover prevention device, a mass of a semi-trailer coupled to the rollover prevention device, or other data or combinations of data obtained by the controller. In other embodiments, one or more rollover conditions comprise one or more combinations of threshold values of a combination of data measured by one or more sensors coupled to the controller or data determined by the controller based on data captured by one or more sensors. Different embodiments may include different types of data in one or more rollover conditions.

In response to receiving the control signal, a separation fastener separates, allowing the top plate of the rollover prevention device to detach from the bottom plate of the rollover prevention device. For example, a separation fastener is a frangible bolt, and explosive charges in the frangible bolt detonate in response to the control signal. As the top plate is used to couple the semi-trailer to the semi-tractor, detaching the top plate allows the semi-trailer to detach from the semi-tractor. Because the center of gravity of the semi-trailer is higher than the center of gravity of the semi-tractor, detaching the semi-trailer from the semi-tractor causes the semi-tractor to self-correct even if the semi-trailer continues to rollover after detaching from the semi-tractor.

Other embodiments may include a controller for fifth wheel connector that does not necessarily include the separable fasteners. In this embodiment, the controller is coupled to one or more sensors, or includes one or more sensors, as further described above. Based on data obtained from one or more of the sensors, the controller determines one or more different quantities. For example, a controller determines a roll rate and/or a roll angle of the fifth wheel based on data received from one or more accelerometers or one or more gyroscopes. The sensed data may be provided to a driver of the semi-tractor, to a fleet administrator, or may be applied to other control instrumentation associated with the semi-tractor and/or semi-trailer.

In another embodiment, a fifth wheel connector (that may or may not include the separable fasteners for rollover prevention) includes an actuator or may be coupled to an actuator associated with a guiding system having a lower plate configured to be coupled to a surface of a semi-tractor. A controller included in the fifth wheel connector provides one or more movement signals to the actuator, which causes movement of the fifth wheel connector along the guiding system. For example, repositioning the fifth wheel connector along the guiding system via the actuator is used in combination with control of brakes for wheels to reposition the suspension of the semi-trailer relative to the semi-tractor By repositioning the suspension of the semi-trailer, mass is redistributed between axles of the semi-trailer suspension and axles of the semi-tractor suspension to comply with axle load specifications or other factors. This slider system may be used in embodiments in which the fifth wheel connector includes the separable fasteners for rollover prevention or in conjunction with a passive fifth wheel connector that does not necessarily include the separable fasteners.

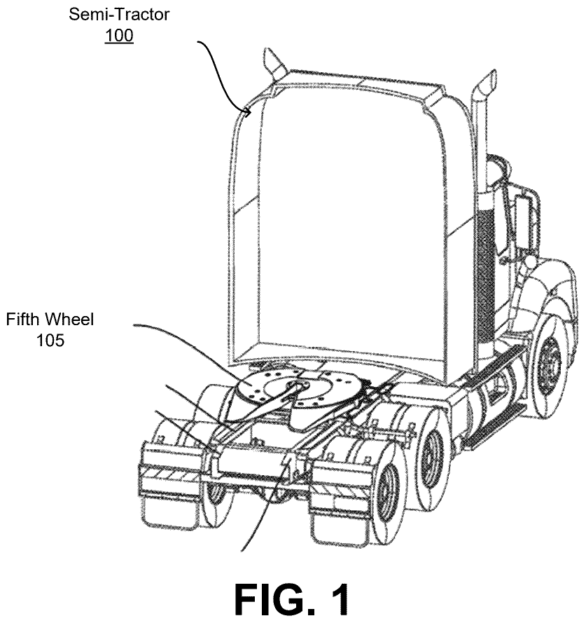

FIG. 1 is a perspective view of an example location on a semi-tractor 100 where a fifth wheel 105 is typically installed. The fifth wheel 105 is a coupling device positioned at a rear of the semi-tractor. The fifth wheel 105 includes a horseshoe-shaped opening through which a kingpin protruding from a bottom front surface of a semi-trailer is inserted. When a semi-trailer is coupled to the semi-tractor 100 through the fifth wheel 105, as the semi-tractor 100 turns, a surface of the semi-trailer having the kingpin at its center rotates against a top surface of the fixed fifth wheel 105, which does not rotate.

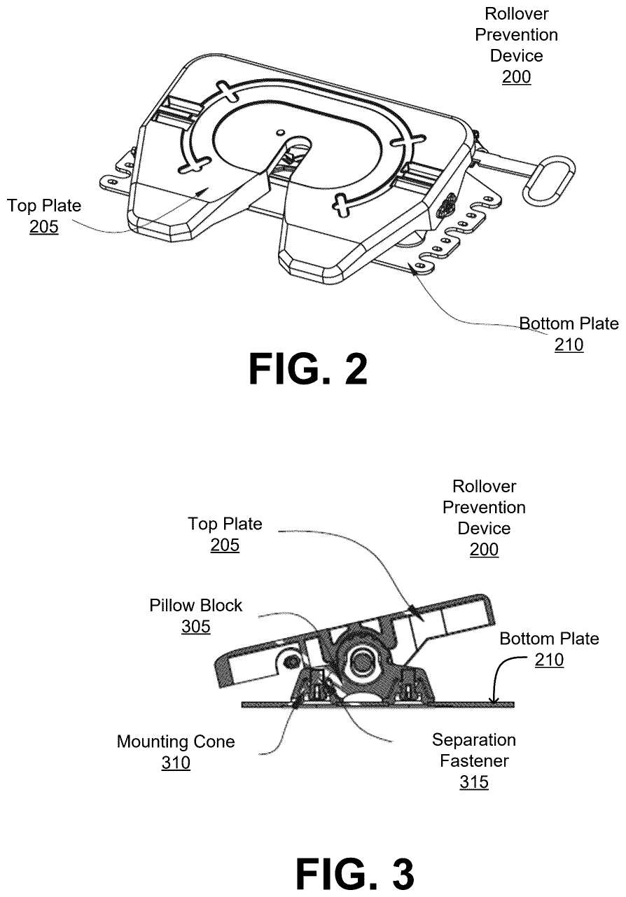

FIG. 2 is a top perspective view of one embodiment of a rollover prevention device 200. As shown in FIG. 2, the rollover prevention device 200 comprises a top plate 205 that is coupled to a bottom plate 210. The rollover prevention device 200 is positioned at location of the fifth wheel 105 of the semi-tractor 100 in various embodiments. The top plate 205 includes a horseshoe-shaped opening configured to receive a kingpin of a semi-trailer. The bottom plate 210 is configured to be coupled to a portion of a semi-tractor 100. In various embodiments, the bottom plate 210 is bolted to a surface of the semi-tractor 100, while in other embodiments the bottom plate 210 is coupled to the surface of the semi-tractor 100 using one or more alternative or additional coupling mechanisms.

FIG. 3 is a side cross-section view of an embodiment of the rollover prevention device 200 with the top plate 205 installed. As shown in FIG. 3, the top plate 205 is coupled to one or more pillow blocks 305 and the bottom plate 210 includes one or more mounting cones 310. The mounting cones 310 are rigidly attached to the bottom plate 210. Example mechanisms for attaching the mounting cones 310 to the bottom plate 210 include welding the mounting cones 310 to the bottom plate or bolting the mounting cones 310 to the bottom plate 210.

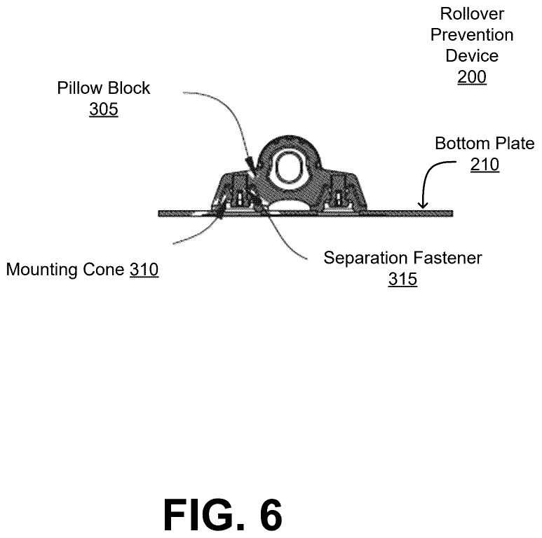

A mounting cone 310 extends from the bottom plate 210 into a cavity within a pillow block 305. Each mounting cone 310 is inserted into a cavity in a corresponding pillow block 305. Inserting mounting cones 310 into cavities of corresponding pillow blocks 305 prevents the fifth wheel and semi-trailer from laterally or longitudinally sliding off the semi-tractor under non-rollover conditions. With the mounting cones 310 inserted into cavities of the pillow blocks 305, the top plate 205 is lifted vertically from the bottom plate 210 or the top plate 205 is vertically pivoted about a portion of the bottom plate 210, as further described above in conjunction with FIG. 6. Additionally, having the mounting cones 310 insert into cavities on corresponding pillow blocks 305 reduces a likelihood of a semi-trailer coupled to the top plate 205 moving forward and into a rear of a semi-tractor to which the bottom plate 210 is coupled.

Additionally, a pillow block 305 is further coupled to the bottom plate 210 through one or more separation fasteners 315. In various embodiments, a separation fastener 315 comprises a frangible bolt configured to separate into multiple pieces in response to receiving a control signal. Various mechanisms may be used for the separation fastener 315 to separate into multiple pieces in various embodiments. In various embodiments, a separation fastener 315 is inserted through the mounting cone 310 into a portion of a pillow block 305 having a cavity into which the mounting cone is inserted 310. A separation fastener 315 is inserted into the mounting cone 310, where the head of the separation fastener 315 is proximate to the bottom plate 210 in various embodiments. The pillow block 305 includes a threaded hole having internal threads that interlock with threads of the separation fastener 315 when the separation fastener 315 is inserted into the threaded hold of the pillow block 305.

A frangible bolt may include one or more explosive charges capable of being detonated in response to a control signal. For example, the frangible bolt has a partially hollow shaft filled with an explosive material. In various embodiments, the frangible bolt receives a control signal to detonate one or more of the explosive charges. For example, the control signal may cause a threshold amount of current to flow through a heating element that causes detonation. When the one or more explosive charges detonate, the frangible bolt separates into two or more pieces. Positioning of the one or more explosive charges in the frangible bolt determines locations where the frangible bolt separates into pieces. Different types of separation fasteners may be used to couple the top plate 205 to the bottom plate 210 in various embodiments. For example, one or more frangible nuts are used to fasten the top plate 205 to the bottom plate 210. The frangible nuts include explosive material configured to detonate in response to receiving a control signal, as further described above. In further embodiments, other types of separation fasteners that do not necessarily utilize explosives may be used to couple the top plate 205 to the bottom plate 210 that are capable of detaching the top plate 205 from the bottom plate 210 in response to receiving a control signal. For example, separable fasteners may be separable based on electronically actuated release mechanisms, materials that separate in response to temperature changes, or other separation mechanisms.

When the separation fasteners 315 are separated in a non-rollover condition, the top plate 205 remains coupled to the bottom plate 210 by the mounting cones 310 inserted into the pillow blocks 305 (based on force of gravity). However, the plates 205, 210 will separate in a rollover condition when a portion of the top plate 205 has an appropriate orientation relative to a portion of the bottom plate 210. Under rollover conditions, the top plate 205 is oriented relative to the bottom plate 210 to enable the one or more pillow blocks 305 to lift from corresponding mounting cones 310 on the bottom plate 210. Hence, the mounting cones 310 and corresponding cavities of the pillow blocks 305 into which the mounting cones 310 are inserted operate as secondary securing mechanisms coupling the top plate 205 to the bottom plate 210. This structure enables a semi-trailer to remain coupled to the semi-tractor even if the separation fasteners 315 are inadvertently separated (e.g., due to a fault condition in the sensor or controller) in the absence of an imminent rollover of the semi-trailer. However, during a rollover condition the top plate 205 pivots about a portion of the bottom plate 210 and causes one or more of the pillow blocks 305 to lift away from a corresponding mounting cone 310 of the bottom plate 210, thereby causing the top plate 205 to separate from the bottom plate 210 of the rollover prevention device 200. In various embodiments, the specific orientation of the portion of the top plate 205 to the portion of the bottom plate 210 that allows for separation may correspond to one or more rollover conditions maintained by the controller, as further described below (e.g., based on roll angle in combination with roll rate or other factors).

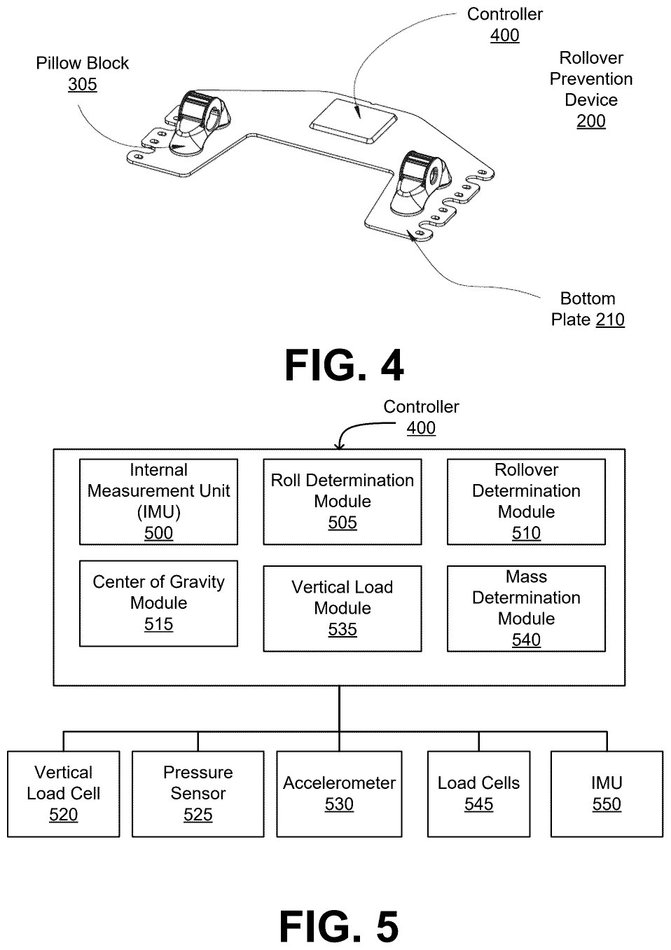

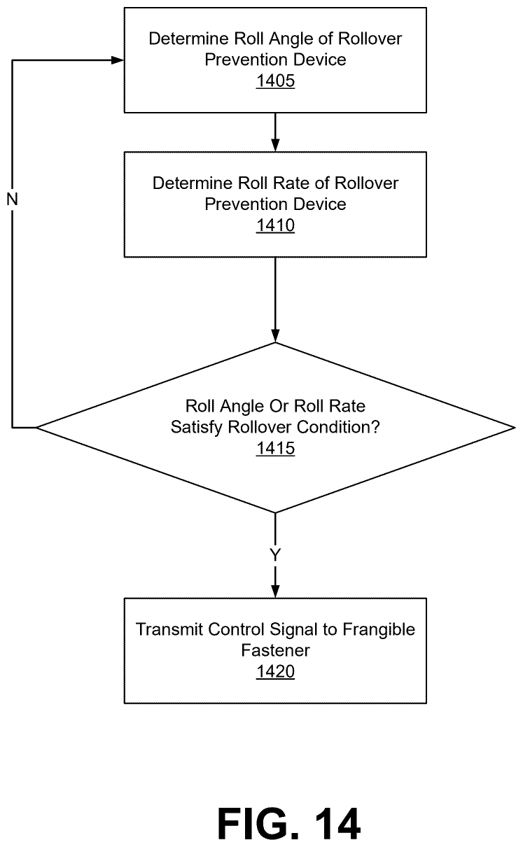

As further described below in conjunction with FIGS. 4 and 14, a controller of the rollover prevention device 200 generates one or more control signals for causes separation of the separation fastener 315 (e.g., detonating frangible fasteners or initiating other separation mechanism). The controller determines whether to transmit a control signal to a separation fastener based on analysis of data captured by one or more sensors, as further described below in conjunction with FIGS. 4 and 14. The controller may generate other data or capture other types of data in various embodiments.

FIG. 4 is a top perspective view of one embodiment of the rollover prevention device 200 without a top plate 205 installed. As shown in FIG. 4, one or more pillow blocks 305 are coupled to the bottom plate 210 of the rollover prevention device 200, as further described above in conjunction with FIG. 2. The top plate 205 couples to the one or more pillow blocks 305, as further described above in conjunction with FIG. 2. Additionally, the rollover prevention device 200 shown in FIG. 4 has a controller 400 coupled to the bottom plate 210. While FIG. 4 shows an embodiment with the controller 400 coupled to the bottom plate 210, in other embodiments the controller 400 may be a discrete component positioned proximate to the bottom plate 210 and coupled to one or more of the separation fasteners 315.

FIG. 5 illustrates a block diagram of one embodiment of a controller 400. For purposes of illustration, the controller 400 is described as included in or coupled to a rollover prevention device 200. However, in various embodiments, the controller 400 may instead be included in or coupled to a fifth wheel connector 105 that does not include one or more separable fasteners 315 for rollover prevention. Various functionality of the controller 400 unrelated to controlling a rollover prevention device 200 may therefore be provided in embodiments where the controller 400 is coupled to (or included in) a fifth wheel 105 without separable fasteners.

In various embodiments, the controller 400 includes an inertial measurement unit (IMU) 500 including one or more sensors. For example, the IMU 500 includes a three-axis accelerometer measuring acceleration in three orthogonal directions. In some embodiments, the IMU 500 includes a three-axis accelerometer and a three-axis gyroscope that determines angular velocity in one or more directions. Alternatively, the IMU 500 includes a gyroscope without an accelerometer. However, in other embodiments, the IMU 500 includes additional sensors, such as a magnetometer or a position sensor (e.g., a global positioning system (GPS) sensor). Multiple sensors may be included in the controller 400 in various embodiments. Further, in some embodiments, the IMU 500 is external to the controller 400 and communicatively coupled, through a wireless communication channel or a wired communication channel, to the controller 400. Additional types of sensors may be included in the controller 400 or coupled to the controller 400 in various embodiments. In other embodiments, the IMU 500 is external to the controller 400 and is communicatively coupled to the controller 400. Further in some embodiments, an additional IMU 550 is coupled to the controller 400.

Based on acceleration measured in different directions by a multi-axis accelerometer (e.g., a multi-axis accelerometer included in the IMU 500), a roll determination module 505 of the controller 400 determines a roll angle of the rollover prevention device 200, or a roll angle of a position where a sensor including an accelerometer is positioned. In various embodiments, the controller 400 includes a processor that receives data from the IMU 500, or from additional sensors, and determines the roll angle or the roll rate or the rollover prevention device 200. In various embodiments, the determined roll angle is measured relative to a horizontal axis orthogonal to the sensor, providing a measure of a deviation from horizontal of the position of the sensor (e.g., at the rollover prevention device 200). Additionally, the roll determination module 505 determines a roll rate of the rollover prevention device 200 based on data captured by the multi-axis accelerometer (e.g., included in the IMU 500) or other sensor coupled to the controller 400. The roll rate indicates a change in the roll angle relative to an axis of the rollover prevention device 200 (or of a sensor location) over time. For example, the roll rate indicates a rate at which the roll angle of the rollover prevention device 200 relative to a horizontal axis orthogonal to the sensor (e.g., the IMU 500) over time. In various embodiments, the roll determination module determines the roll rate in degrees per second or in radians per second.

The controller 400 includes a rollover determination module 510 determines whether the roll angle or the roll rate satisfy a rollover condition. In various embodiments, the rollover determination module 510 stores a table of rollover conditions to which the roll angle and/or the roll rate are compared. In various embodiments, the rollover determination module 510 determines a rollover condition is satisfied when a determined roll angle is within a threshold amount or exceeds a threshold roll angle. The threshold roll angle is predetermined and stored by the rollover determination module 510 in some embodiments. In other embodiments, one or more rollover conditions comprise one or more combinations of threshold values of a combination of data measured by one or more sensors coupled to the controller or data determined by the controller based on data captured by one or more sensors. Different embodiments may include different types of data in one or more rollover conditions One or more rollover conditions may be stored in a non-volatile storage device, such as a solid state memory, in various embodiments. Alternatively, the rollover determination module 510 dynamically determines the threshold roll angle based on data captured by one or more sensors, as further described below. In response to determining the determined roll angle is within the threshold amount or exceeds the threshold roll angle, the rollover determination module 510 transmits a control signal to separation fastener 315 (such as frangible fasteners), of the rollover prevention device 200. As further described above in conjunction with FIG. 2, in response to receiving the control signal, in embodiments where the separation fasteners 315 comprise frangible bolts, explosive charges in the frangible bolts detonate to separate the frangible bolt into two or more pieces. Detonating the frangible bolt (or separating another separation fastener 315) allows the top plate 205 of the rollover prevention device 200 coupled to a semi-tractor to detach from the bottom plate of the rollover prevention device 200 when the roll angle of the rollover prevention device 200 equals or exceeds the threshold roll angle.

In other situations, the rollover determination module 510 may determine that a rollover condition is satisfied in response to determining a roll rate of the rollover prevention device 200 equals or exceeds a threshold roll rate. For example, having a roll rate greater than a threshold rate, even when the roll angle is greater than the threshold amount from the threshold roll angle satisfies a rollover condition indicating an increased likelihood of a semi-trailer coupled to the top plate 205 of the rollover prevention device rolling over. To mitigate this risk, the table maintained by the rollover determination module 510 includes one or more rollover conditions comprising different roll angles, or ranges of roll angles, associated with threshold roll rates. In response to a roll rate determined by the roll determination module 505 equaling or exceeding a threshold rate associated with a roll angle determined by the roll determination module 505, the rollover determination module 510 transmits a control signal to the separation fastener 315 to separate the separation fasteners 315 (e.g., to detonate an explosive charge in the frangible bolts), as further described above. Maintaining the table of threshold roll rates in association with roll angles allows determination of whether a rollover condition is satisfied based on different combinations of roll angle and roll rate that the rollover determination module 510 receives as inputs. This allows the separation fastener 315 to be separated (e.g., detonated) based on threshold roll rates that may vary for different ranges of roll angle, providing protection against a wider range of potential rollover conditions.

In some embodiments, the controller 400 includes a center of gravity module 515 that determines a center of gravity of a semi-trailer coupled to the rollover prevention device 200 and uses the center of gravity to as a factor in determining one or more rollover conditions for the semi-trailer based on how the semi-trailer is loaded. To determine the center of gravity of the semi-trailer, the controller 400 is coupled to one or more vertical load cells 520 included in the rollover prevention device 200. A vertical load cell 520 determines a vertical load applied to the rollover prevention device 200 by a semi-trailer coupled to the rollover prevention device 200. In various embodiments, a vertical load cell 520 is coupled to the controller 400 through a wired connection, while in other embodiments a vertical load cell 520 is wirelessly coupled to the controller 400. Different types of vertical load cells 520 may be used in different embodiments. Hence, the controller 400 receives the vertical load applied to the rollover prevention device 200 by a semi-trailer coupled to the rollover prevention device 200 from the one or more vertical load cells 520.

Alternatively, the controller 400 is coupled to one or more pressure sensors 525 mounted in a suspension of a semi-trailer coupled to the rollover prevention device 200 or is coupled to one or more pressure sensors 525 mounted in a suspension of a semi-tractor 100 coupled to the rollover prevention device 200. The pressure sensors 525 may be positioned in the suspension of the semi-trailer proximate to the rollover prevention device 200 in various embodiments. A pressure sensor 525 determines a downward pressure applied by a load to the pressure sensors 525, which is communicated to the controller 400 through a wireless communication channel or through a wired communication channel.

In other embodiments, the controller 400 captures oscillation of the rollover prevention device 200 through one or more accelerometers 530, such as an accelerometer included in the IMU 500 or another accelerometer 530. For example, the controller 400 captures vertical oscillation of the rollover prevention device 220 captured by one or more accelerometers 530. However, in other embodiments, the controller 400 captures oscillations of the rollover prevention device 220 along one or more axes. For example, the controller 400 captures one or more of vertical oscillation, lateral oscillation, or longitudinal oscillation of the rollover prevention device 200 captured by one or more accelerometers. As another example, the controller 400 captures one or more of roll oscillation, pitch oscillation, or yaw oscillation captured by one or more gyroscopes or IMUs 500, 550. One or more of the accelerometers may be included in the controller 400 or one or more accelerometers 530 may be external to the controller 400 and communicatively coupled to the controller 400. In some embodiments, one or more accelerometers 530 are included in the controller 400, while one or more additional accelerometers 530 are external to the controller 400 and coupled to the controller 400. Based on data from one or more sensors coupled to the controller (e.g., accelerometers 530) the controller 400 determines a distribution of oscillation frequencies of the rollover prevention device 200 along one or more axes (e.g., a distribution of vertical oscillation frequencies). The controller 400 includes a vertical load module 535 that applies a trained machine-learning model to the distribution of oscillation frequencies, with the machine-learning model generating a vertical load applied to the rollover prevention device 200 from the distribution of oscillation frequencies. In various embodiments, the machine-learning model receives a Fourier transform of the distribution of oscillation frequencies as input and outputs a vertical load applied to the rollover prevention device 200 based on the Fourier transform. In various embodiments, the machine-learning model receives a distribution of oscillation frequencies of the rollover prevention device 200 along one or more axes, or one or more quantities based on one or more oscillation frequencies to determine a load applied to the rollover prevention device 200, or another characteristic of the semi-tractor 100 or of the semi-trailer. For example, oscillation frequencies along six axes are received by the machine-learning model as input to determine one or more characteristics of the semi-tractor 100 or of the semi-trailer. In various embodiments, a the machine-learning model comprises a physics-based model fitted to a training dataset (e.g., a historical dataset of Fourier transforms of oscillation frequencies, a time history dataset of oscillation, etc.) obtained by a computing device coupled to the controller 400 to determine vertical load of another characteristic of the semi-tractor 100 or the semi-trailer dataset, whether, to determine vehicle characteristics such as vertical load.

In various embodiments, a computing device coupled to the controller 400, trains the machine-learning model based on a training dataset including multiple training examples. Each training example includes a training distribution of oscillation frequencies (e.g., vertical oscillation frequencies, oscillation frequencies along multiple axes) and has a label indicating a vertical load corresponding to the training distribution of oscillation frequencies. To train the machine-learning model, a set of weights comprising the machine-learning model are initialized, and the machine-learning model is applied to each training example of the training dataset.

Applying the machine-learning model to multiple training examples updates the parameters (e.g., the weights) comprising the machine-learning model. The parameters comprising the machine-learning model transform the input data—the distribution of oscillation frequencies—into a vertical load applied to the rollover prevention device 200. When applied to a training example, the machine-learning model generates a predicted vertical load applied to the rollover prevention device 200.

For each training example to which the machine-learning model is applied, a computing device coupled to the controller 400 (e.g., a server coupled to the controller 400 via a network) generates a score comprising an error term based on the predicted vertical load applied to the rollover prevention device 200 and the label applied to the training example. The error term is larger when a difference between the predicted vertical load applied to the rollover prevention device 200 and the label applied to the training example is larger. Similarly, the error term is smaller when the difference between the predicted vertical load applied to the rollover prevention device 200 and the label applied to the training example is smaller. In various embodiments, the vertical load module 535, or a computing device coupled to the controller 400, generates the error term using a loss function based on a difference between the predicted vertical load applied to the rollover prevention device 200 and the label applied to the training example using a loss function. Example loss functions include a mean square error function, a mean absolute error, a hinge loss function, and a cross-entropy loss function.

A computing device coupled to the controller 400, backpropagates the error term to update the set of parameters comprising the machine-learning model and stops backpropagation in response to the error term, or to the loss function, satisfying one or more criteria. For example, computing device backpropagates the error term through the machine-learning model to update parameters of the machine-learning model until the error term has less than a threshold value. For example, the computing device coupled to the controller 400, may apply gradient descent to update the set of parameters. The computing device coupled to the controller 400, stores the set of parameters comprising the machine-learning model on a non-transitory computer readable storage medium after stopping the backpropagation. Subsequently, the computing device transmits the trained machine-learning model to the controller 400, which stores the trained machine-learning model in the vertical load module 535 for application. Alternatively, the machine-learning model may be stored in a cloud environment and may be accessed by the controller 400 via a network connection.

The vertical load module 535 may dynamically retrain the machine-learning model or transmit data to a computing device for retraining the machine-learning model over time. For example, the vertical load module 535 receives a measured vertical load for the rollover prevention device 200 that is associated with a distribution of sensed vertical oscillation frequencies. The vertical load module 535, or the computing device coupled to the controller 400, uses the combination of measured vertical load and distribution of sensed vertical oscillation frequencies as a training example for the machine-learning model to modify one or more parameters of the machine-learning model as further described above. In some embodiments, the machine-learning model is locally stored by the vertical load module 535, which applies the machine-learning model to sensed vertical oscillation frequencies received by the one or more accelerometers 530. Alternatively, the controller 400 transmits sensed vertical oscillation frequencies to a computing device via a wireless or a wired communication channel, the computing device applies the machine-learning model to the sensed vertical oscillation frequences, and transmits a vertical load applied to the rollover prevention device 200 to the controller 400 via the wireless or wired communication channel.

In various embodiments, the controller 400 also includes a mass determination module 540 configured to determines a mass of a semi-trailer coupled to the rollover prevention device 200. In some embodiments, the controller 400 is coupled to one or more load cells 545 positioned in the rollover prevention device 200. The load cells 545 measure a force used to accelerate a semi-trailer coupled to the rollover prevention device 200 during acceleration of the semi-trailer. Based on the measured force and a measured acceleration of the semi-trailer coupled to the rollover prevention device 200, the mass determination module 540 determines the mass of the semi-trailer coupled to the rollover prevention device 200. For example, the mass of the semi-trailer is determined as a ratio of the measured force to the measured acceleration of the semi-trailer. As further described above, the center of gravity module 515 determines a center of gravity of the semi-trailer based at least in part on the mass of the semi-trailer, and may account for the center of gravity of the semi-trailer in one or more rollover conditions in various embodiments.

In other embodiments, the mass determination module 540 additionally or alternatively determines a mass of a semi-trailer coupled to the rollover prevention device 200 based on vertical load applied to the rollover prevention device 200 for each of a plurality of positions of a suspension of the semi-trailer. For example, one or more vertical load cells 520 included in the rollover prevention device 200 and coupled to the controller 400 determine a first vertical load applied to the rollover prevention device 200 by a semi-trailer coupled to the rollover prevention device 200 when the suspension of the semi-trailer is in a first position. The one or more vertical load cells 520 included in the rollover prevention device 200 and coupled to the controller 400 also determine a second vertical load applied to the rollover prevention device 200 by a semi-trailer coupled to the rollover prevention device 200 when the suspension of the semi-trailer is in a second position. Based on the first vertical load, the second vertical load, and a distance between the first position of the suspension and the second position of the suspension, the mass determination module 540 determines the mass of the semi-trailer.

In various embodiments, the center of gravity module 515 may receive data from one or more sensors measuring a frequency of roll oscillations of the rollover prevention device 200 while a semi-tractor 100 coupled to the rollover prevention device 200 is in motion. In various embodiments, one or more accelerometers 530 included in the controller 400, or coupled to the controller 400, captures the frequency of roll oscillations. Alternatively or additionally, one or more gyroscopes or load cells 565 coupled to the controller 400, or included in the controller 400 capture a frequency of roll oscillations of the rollover prevention device 200. Based on the mass of the semi-trailer (which may be determined by the mass determination module 540, as further described above) and the frequency of roll oscillations of the rollover prevention device 200, the center of gravity module 515 determines a height of a center of gravity of the semi-trailer. In various embodiments, the rollover determination module 510 modifies one or more rollover conditions, such as a threshold roll angle or a threshold roll rate, based on the height of the center of gravity of the semi-trailer. For example, the rollover determination module decreases the threshold roll angle or the threshold roll rate in response to determining a height of the center of gravity of the semi-trailer is greater than a threshold height or in response to determining the height of the center of gravity of the semi-trailer increases by at least a threshold amount from a previously determined height. As another example, the rollover determination module increases the threshold roll angle and/or the threshold roll rate (or otherwise dynamically modifies the detection criteria for the rollover condition) in response to determining a height of the center of gravity of the semi-trailer is less than an additional threshold height or in response to determining the height of the center of gravity of the semi-trailer decreases by at least a threshold amount from a previously determined height.

Additionally, the controller 400 may transmit a warning signal to one or more devices in response to determining a height of the center of gravity of the semi-trailer equals or exceeds the threshold height. Determining the height of the center of gravity of the semi-trailer equals or exceeds the threshold height equals or exceeds the threshold height indicates loading of cargo in the semi-trailer increases a likelihood of the semi-trailer rolling over while in motion. The warning signal may be transmitted from the controller 400 to a client device in the semi-tractor 100 (e.g., a client device of a driver of the semi-tractor 100, a computing device included in the semi-tractor 100, etc.). Additionally or alternatively, the warning signal may be transmitted from the controller 400 to a remote client device, such as a client device of an entity associated with the semi-tractor 100. The warning signal provides a driver or other entity with advanced warning of an increased risk of the semi-trailer rolling over, allowing a driver to take preventive action to mitigate the risk of the semi-trailer rolling over (e.g., reconfiguring cargo in the semi-trailer, altering one or more driving characteristics, etc.).

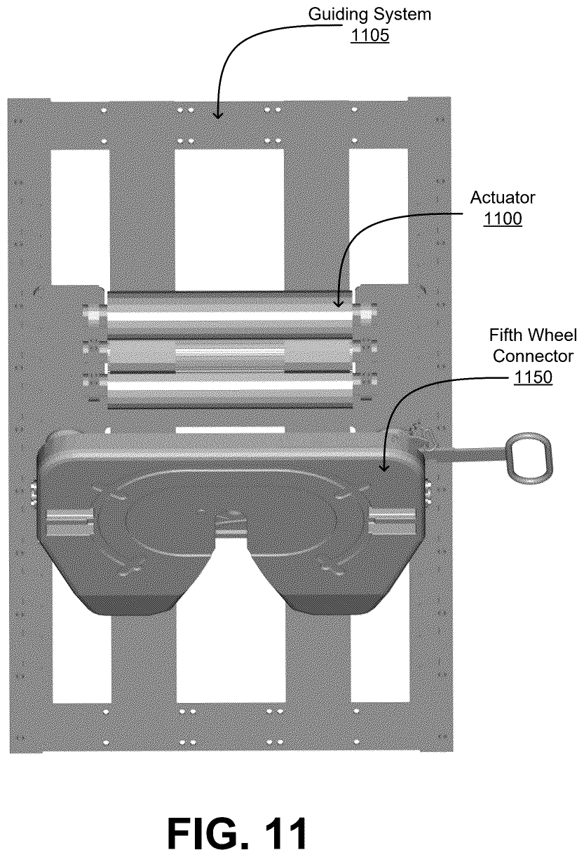

In various embodiments, based on the vertical load applied to the rollover prevention device 200 by a semi-trailer coupled to the rollover prevention device 200, the mass of the semi-trailer coupled to the rollover prevention device 200, and a specified weight of the semi-trailer without cargo, the mass determination module 540 determines a mass of the semi-trailer on each axle of the semi-tractor 100 or each axle of the semi-trailer. Determining the mass of the semi-trailer on each axle of the semi-tractor 100 or of the semi-trailer allows the mass determination module 540 to determine whether one or more portions of the suspension supporting the semi-trailer are capable of being repositioned. For example, the mass determination module maintains a threshold load on various axles of the suspension supporting the semi-trailer, and determines whether a load on an axle of the semi-trailer (or an axle of the semi-tractor 100) is less than the threshold mass when the axle when the suspension of the semi-trailer is in a specific position. The controller 400 prevents repositioning the suspension to the specific position in response to the load on the axle of the semi-trailer (or the axle of the semi-tractor 100) equaling or exceeding the threshold mass. As further described below in conjunction with FIG. 11, the rollover prevention device 200 may be repositioned along a portion of the semi-tractor 100 based on one or more movement signals from the controller 400 in various embodiments. Repositioning the rollover prevention device 200 repositions a portion of the suspension of the semi-trailer, and the controller 400 prevents repositioning of the semi-trailer suspension to a position where a load on an axle of the semi-trailer suspension (or a mass of an axle of the semi-tractor 100 suspension) equals or exceeds the threshold mass.

While FIG. 4 shows an example rollover prevention device 200 including the controller 400, in alternative embodiments, the controller 400 is included in or coupled to a fifth wheel 105 configured to couple a semi-trailer to a semi-tractor 100, such as a fifth wheel 105 that does not include one or more frangible fasteners. When included in or coupled to a fifth wheel 105, the controller 400 includes one or more of the IMU 500, the roll determination module 505, the center of gravity module 515, the vertical load module 535, and the mass determination module 540. Similarly, a controller included in a fifth wheel 105 may be coupled to one or more vertical load cells 520, one or more pressure sensors 525, one or more accelerometers 530, and one or more load cells 545.

A controller 400 included in a fifth wheel 105 or coupled to a fifth wheel 105 determines a center of gravity of a semi-trailer coupled to the fifth wheel 105 and may generate a warning signal or other message in response to the center of gravity satisfying one or more conditions. The warning may be transmitted to a client device of a driver of the semi-tractor or to a computing device of an entity associated with the semi-tractor. As further described above, the center of gravity module 515 of a controller included in or coupled to the fifth wheel 105 determines the center of gravity of the semi-trailer coupled to the fifth wheel 105 based on data from one or more vertical load cells 520 included in the fifth wheel 105 that determine vertical load applied to the fifth wheel 105.

Alternatively, the controller 400 is coupled to one or more pressure sensors 525 mounted in a suspension of a semi-trailer coupled to the fifth wheel 105 or is coupled to one or more pressure sensors 525 mounted in a suspension of a semi-tractor 100 coupled to the fifth wheel 105. The pressure sensors 525 may be positioned in the suspension of the semi-trailer proximate to the fifth wheel 105 in various embodiments. A pressure sensor 525 determines a downward pressure applied by a load to the pressure sensors 525, which is communicated to the controller 400 through a wireless communication channel or through a wired communication channel.

In other embodiments, the controller 400 captures oscillation of the fifth wheel 105 through one or more sensors, as further described above. Based on data from the one or more accelerometers 530, the controller 400 determines a distribution of oscillation frequencies of the fifth wheel 105 and determines one or more characteristics of the semi-tractor 100 or the semi-trailer through application of a trained machine-learning model to the distribution of oscillation frequencies, as further described above.

As further described above, the controller 400 also includes a mass determination module 540 configured to determine a mass of a semi-trailer coupled to the fifth wheel 105. In some embodiments, the controller 400 is coupled to one or more load cells 545 positioned in the fifth wheel 105. The load cells 545 measure a force used to accelerate a semi-trailer coupled to the fifth wheel 105 during acceleration of the semi-trailer. Based on the measured force and a measured acceleration of the semi-trailer coupled to the fifth wheel 105, the mass determination module 540 determines the mass of the semi-trailer coupled to the fifth wheel 105. For example, the mass of the semi-trailer is determined as a ratio of the measured force to the measured acceleration of the semi-trailer. As further described above, the center of gravity module 515 determines a center of gravity of the semi-trailer based at least in part on the mass of the semi-trailer, and may account for the center of gravity of the semi-trailer in one or more rollover conditions in various embodiments.

In other embodiments, the mass determination module 540 additionally or alternatively determines a mass of a semi-trailer coupled to the fifth wheel 105 based on vertical load applied to the fifth wheel 105 for each of a plurality of positions of a suspension of the semi-trailer. For example, one or more vertical load cells 520 included in the fifth wheel 105 and coupled to the controller 400 determine a first vertical load applied to the fifth wheel 105 by a semi-trailer coupled to the fifth wheel 105 when the suspension of the semi-trailer is in a first position. The one or more vertical load cells 520 included in the fifth wheel 105 and coupled to the controller 400 also determine a second vertical load applied to the fifth wheel 105 by a semi-trailer coupled to the fifth wheel 105 when the suspension of the semi-trailer is in a second position. Based on the first vertical load, the second vertical load, and a distance between the first position of the suspension and the second position of the suspension, the mass determination module 540 determines the mass of the semi-trailer.

In various embodiments, the center of gravity module 515 may receive data from one or more sensors measuring a frequency of roll oscillations of the fifth wheel 105 while a semi-tractor 100 coupled to the fifth wheel 105 is in motion. In various embodiments, one or more accelerometers 530 included in the controller 400, or coupled to the controller 400, captures the frequency of roll oscillations. Alternatively or additionally, one or more gyroscopes or load cells 545 coupled to the controller 400, or included in the controller 400 capture a frequency of roll oscillations of the rollover prevention device 200. Based on the mass of the semi-trailer (which may be determined by the mass determination module 540, as further described above) and the frequency of roll oscillations of the fifth wheel 105, the center of gravity module 515 determines a height of a center of gravity of the semi-trailer. In various embodiments, the controller 400 transmits a notification to a client device of a driver of the semi-tractor 100 in response to determining the height of the center of gravity of the semi-trailer equals or exceeds a threshold height. Alternatively, or additionally, the controller 400 transmits a notification to a client device of an entity associated with the semi-tractor 100 in response to determining the height of the center of gravity of the semi-trailer equals or exceeds a threshold height.

Hence, the controller 400 may be used in combination with a fifth wheel 105 and to determine a height of a center of gravity of a semi-trailer coupled to the fifth wheel 105 as, further described above, providing information about loading of the semi-trailer to a driver of a semi-tractor 100 or to another entity. Similarly, when used in combination with a fifth wheel 105, the controller 440 may determine a mass of a semi-trailer coupled to the fifth wheel 105 or a mass applied to one or more axles of the semi-trailer or the semi-tractor 100, which may be used to provide notifications to a driver of the semi-tractor 100 or to reposition the semi-trailer relative to the semi-tractor, as further described below in conjunction with FIGS. 11-13B. Hence, various functionalities further described above may be provided by the controller 400 when coupled to, or included in, a fifth wheel 105 that does not include one or more frangible fasteners.

FIG. 6 is a side cross-section view of an example of a rollover prevention device 200 without a top plate 205 installed. As shown in FIG. 6, one or more mounting cones 310 of the bottom plate 210 of the rollover prevention device 200 are inserted into cavities of a pillow block 305. In the example of FIG. 6, the pillow block 305 includes two cavities, with a mounting cone 310 from the bottom plate 210 inserted into each cavity. As further described above in conjunction with FIG. 3, the mounting cones 310 are rigidly attached to the bottom plate 210.

Additionally, the pillow block 305 is coupled to the bottom plate 210 through one or more separation fastener 315. As further described above in conjunction with FIG. 3, a separation fastener 315 is inserted through the mounting cone 310 into a portion of a pillow block 305 having a cavity into which the mounting cone 310 is inserted 310. The cavity of the pillow block 305 includes threads configured to interlock with threads of the separation fastener 315 to couple the pillow block 305 to the bottom plate 210. Hence, the pillow block 305 couples the top plate 205 to the bottom plate 210.

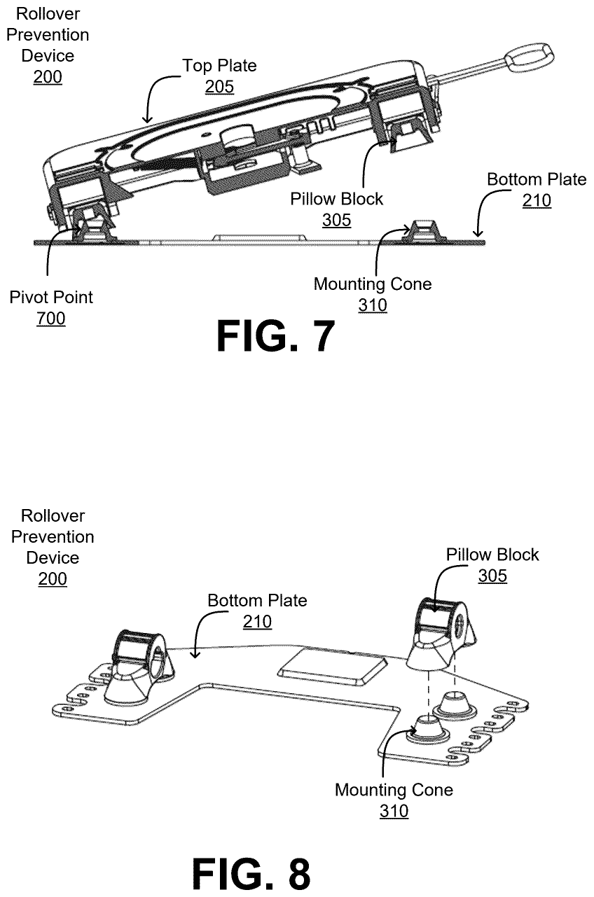

FIG. 7 illustrates an example of a top plate 205 of the rollover prevention device 200 pivoting off of the mounting cones 310 to detach from the bottom plate 210 of the rollover prevention device 200. For example, the top plate 205 pivots about a pivot point 700 on the bottom plate 120. The pivot point 700 is a mounting cone 310 of the bottom plate 210 in various embodiments. As shown in FIG. 7, a side of the top plate 205 distal from the pivot point 700 raises vertically from the bottom plate 210 so a pillow block 305 nearest to the side of the top plate 205 raising vertically from the bottom plate 210 is above the mounting cone 310 nearest to the side of the top plate 205 raising vertically. This detaches the side of the top plate 205 from the bottom plate 210. The top plate 205 may continue to pivot about the pivot point 700 so a pillow block 305 nearest to the pivot point 700 raises above the mounting cone 310 nearest to the pivot point 800 to detach the top plate 205 from the bottom plate 210.

FIG. 8 illustrates one embodiment of assembling pillow blocks 305 of the rollover prevention device 200 onto mounting cones 310 of the rollover prevention device 200. As shown in FIG. 8, a mounting cone 310 is inserted into a cavity of the pillow block 305. In various embodiments, a portion of the cavity of the pillow block 305 includes threads, and a separation fastener 315 is threaded through the mounting cone 310 into the cavity of the pillow block 305 so threads of the separation fastener 315 interlock with the threads of the cavity of the pillow block 305.

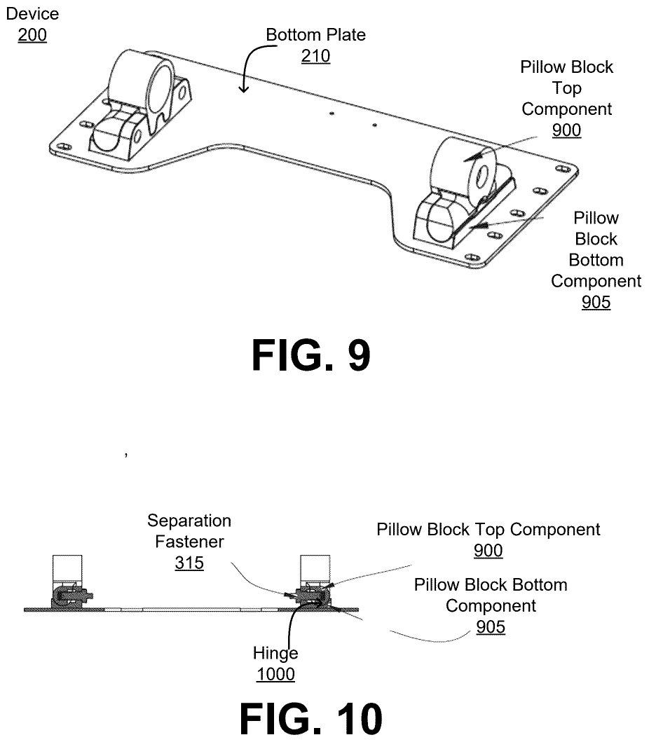

FIG. 9 is a top perspective view of an alternative embodiment of a pillow block 305 and a bottom plate 210 of a rollover prevention device 200. In the embodiment shown by FIG. 9, each pillow block comprises a pillow block top component 900 coupled to a pillow block bottom component 905. For example, a fastener couples to the pillow block top component 900 and to the pillow block bottom competent 905 to couple the pillow block top component 900 to the pillow block bottom component 905. Additionally, the pillow block top component 900 and the pillow block bottom component 905 interlock with each other to prevent forward motion of a semi-trailer coupled to a top plate 205 of the rollover prevention device 200 towards a semi-tractor 100 coupled to the bottom plate 210 of the rollover prevention device 200. For example, a hinge couples the pillow block top component 900 to the pillow block bottom component 805, a further described below in conjunction with FIG. 10. The pillow block top component 900 is configured to be coupled to the top plate 205, while the pillow block bottom component 905 is configured to be coupled to the bottom plate 210.

FIG. 10 is a side cross-sectional view of the alternative embodiment of the pillow block 305 and the bottom plate 210 of a rollover prevention device 200 shown by FIG. 9. As shown by FIG. 10, the pillow block top component 900 is coupled to the pillow block bottom component 905 by a hinge 1000. The hinge 1000 prevents the pillow block top component 900 from separating from the pillow block bottom component 905 unless the pillow block top component 900 is lifted from the pillow block bottom component 905 or unless the pillow block top component 900 is pivoted upward from the pillow block bottom component 905.

Additionally, a separation fastener 315 is inserted horizontally through the pillow block through a portion of the pillow block top component 900 and a portion of the pillow block bottom component 905. The separation fastener 315 extends through the pillow block to at least partially contact the hinge 1000, so the separation fastener 315 secures the hinge 1000. As further described above in conjunction with FIG. 3, in various embodiments a separation fastener 315 comprises a frangible bolt including one or more explosive charges that detonate in response to receiving a control signal. When the separation fastener 315 separates (e.g., a frangible bolt detonates), the pillow block top component 900 separates from the pillow block bottom component 905 when rollover conditions are met (e.g., when a roll angle of the rollover prevention device 200 equals or exceeds a threshold roll angle and/or when a roll rate of the rollover prevention device 200 equals or exceeds a threshold roll rate). When the rollover condition is met, the top plate 205 can pivot about a portion of the bottom plate 210 so the hinge 1000 of a pillow block separates. This detaches the pillow block top component 900 from the pillow block bottom component 905, enabling the top plate 205 to detach from the bottom plate 210 of the rollover prevention device 200.

FIG. 11 is an overhead view of one embodiment of a repositionable fifth wheel connector 1150. In the example of FIG. 11, the repositionable fifth wheel connector 1150 includes, or is coupled to, an actuator 1100 that enables repositioning of the fifth wheel connector 1150 relative to a guiding system 1105 configured to be coupled to a surface of a semi-tractor 100. The fifth wheel connector 1150 may comprise a rollover prevention device 200 that includes separable fasteners 315 as described above or may include a fixed fifth wheel connector that does not necessarily include separable fasteners 315 for rollover prevention.

The actuator 1100 receives one or more movement signals from a controller 400 to control positioning. In response to a movement signal, the actuator 1100 repositions the fifth wheel connector 1150 along the guiding system 1105. For example, a first movement signal moves the fifth wheel connector 1150 along the guiding system 1105 in a direction towards the semi-tractor 100. Similarly, a second movement signal moves the fifth wheel connector 1150 along the guiding system 1105 in a direction away from the semi-tractor 100. In various embodiments, the actuator 1100 comprises a lead screw or a ball screw with an electric motor or a hydraulic motor that receives one or more movement signals from the controller 400. Alternatively, the actuator 1100 comprises a rack and pinion system with an electric motor or a hydraulic motor that receives one or more movement signals from the controller 400. In other embodiments, the actuator 1100 comprises a timing belt, a cable system, or a winch system having an electric motor or a hydraulic motor that receives one or more movement signals from the controller 400.

In various embodiments, repositioning the fifth wheel connector 1150 along the guiding system 1105 via the actuator 1100 may be used in combination with control of wheel brakes to reposition the suspension of the semi-trailer relative to the semi-tractor 100. By repositioning the suspension of the semi-trailer, mass is redistributed between axles of the semi-trailer suspension and axles of the semi-tractor suspension to comply with axle load specifications or other factors. For example, moving the fifth wheel connector 1150 in a first direction along the guiding system 1105 decreases load on an axle of the suspension of the semi-trailer and increases load on an axle of the suspension of the semi-tractor 100. As another example, moving the fifth wheel connector 1150 in a second direction along the guiding system 1105 increases load on an axle of the suspension of the semi-trailer and decreases load on an axle of the suspension of the semi-tractor 100.

In various embodiments, when repositioning the actuator 1100, the controller 400 determines a current and an instantaneous voltage applied to the actuator 1100 to reposition the fifth wheel connector 1150 along the guiding system 1105. From the current and a force conversion factor for the actuator 1100, the controller 400 determines a force applied by the actuator 1100 and determines the mass of the semi-trailer from the determined force. As further described above in conjunction with FIG. 5, the controller 400 determines a center of gravity of the semi-trailer based at least in part on the mass of the semi-trailer. In embodiments equipped with rollover prevention, the center of gravity of the semi-trailer may be utilized, in part, to configure rollover detection conditions and determine when to release the separation fastener 315. Hence, the rollover conditions may change as the fifth wheel connector 1150 is moved to different positions along the guiding system 1105.

Further, repositioning the suspension of the semi-trailer may be based on regulations for regions where the semi-tractor 100 is moving. For example, compliance with different state regulation may involve adjusting locations of semi-trailer suspension relative to the semi-tractor 100 or relative to an end of the semi-trailer. The controller 400 may operate to enable repositioning the fifth wheel connector 1150 to a particular position satisfying a regulation for a region where the semi-tractor 100 is moving. In various embodiments, the controller 400 is coupled to a sensor that determines a position of the semi-trailer suspension. For example, the sensor determining the position of the semi-trailer suspension is a camera, a time-of-flight sensor (e.g., a laser time-of-flight sensor), an ultrasonic sensor, or another sensor capable of determining a position of the suspension of the semi-trailer.

In some embodiments, the controller 400 transmits a movement signal to the actuator 1100 based on a speed of the semi-tractor 100 to which the fifth wheel connector 1150 is coupled. For example, the controller 400 determines or receives a captured speed of the semi-tractor 100 to which the fifth wheel connector 1150 is coupled, and generates a movement signal for the actuator 1100 based at least in part on the speed. For example, the controller 400 generates a movement signal causing the actuator 1100 to move the fifth wheel connector 1150 nearer to the semi-tractor 100 in response to determining the speed equals or exceeds a threshold or in response to determining the speed has increased relative to a prior speed, to reduce drag from airflow over the semi-tractor 100 and the semi-trailer during movement. As another example, the controller 400 generates an alternative a movement signal causing the actuator 1100 to move the fifth wheel connector 1150 farther from the semi-tractor 100 in response to determining the speed is less than an additional threshold or in response to determining the speed has decreased relative to a prior speed, to increase maneuverability of the semi-tractor 100.

In various embodiments, one or more movement signals generated by the controller 400 are also based on a load on an axle of the semi-trailer and a load on an axle of the semi-tractor 100 when the suspension of the semi-trailer is in a particular position. For example, in response to determining an updated position of the suspension of the semi-trailer based on a speed of semi-tractor coupled to the semi-trailer, the controller 400 determines whether the updated position of the suspension of the semi-trailer results in a load on the axle of the semi-tractor 100 that equals or exceeds a threshold value. Determination of the load on one or more axles is further described above in conjunction with FIG. 5. In response to the updated position of the suspension of the semi-trailer resulting in a load on the axle of the semi-tractor 100 that equals or exceeds a threshold value, the controller 400 determines an alternative position of the suspension of the semi-trailer resulting the load on the axle of the semi-tractor 100 being less than the threshold value and transmits a movement signal to the actuator 1100 based on the updated position. This prevents the controller 400 from repositioning the suspension of the semi-trailer to a position where the load on the axle of the semi-tractor 100 exceeds a threshold.

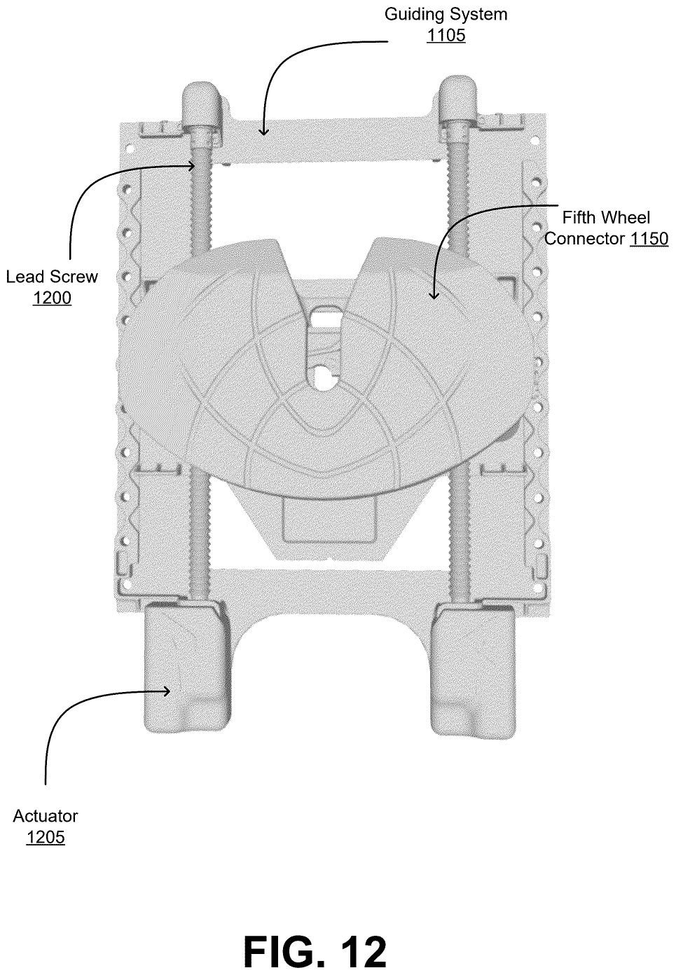

FIG. 12 is an overhead view of an alternative embodiment of a repositionable fifth wheel connector 1150. The fifth wheel connector 1150 is coupled to a guiding system 1105 as described above to enable repositioning. For example, a bottom plate of the fifth wheel connector 1150 is coupled to the guiding system 1105. The guiding system 1105 is configured to be coupled to a surface of a semi-tractor 100.

The guiding system 1105 includes one or more lead screws 1200 coupled to the fifth wheel connector 1150. For example, the bottom plate of the fifth wheel connector 1150 includes one or more threaded holes, and a lead screw 1200 is inserted into a corresponding threaded hole. Each lead screw 1200 is coupled to an actuator 1205. Each lead screw 1200 may be coupled to a corresponding discrete actuator 1205 in some embodiments, while in other embodiments a common actuator is coupled to a common actuator 1205. In various embodiments, the actuator 1205 comprises an electric motor or a hydraulic motor that receives one or more movement signals from the controller 400. An actuator 1205 receives one or more movement signals from the controller 400 of the fifth wheel connector 1150. In the example of FIG. 12, each lead screw 1200 is coupled to an end of the guiding system 1105 opposite an end of the guiding system 1105 proximate to the actuator 1205, so a lead screw 1200 spans a length of the guiding system 1105 and runs underneath the fifth wheel connector 1150.

In response to a movement signal, the actuator 1205 repositions the fifth wheel connector 1150 along the guiding system 1105. For example, a first movement signal causes the actuator 1205 to rotate a lead screw 1200 clockwise, which moves the fifth wheel connector 1150 along the guiding system 1105 in a first direction relative to the semi-tractor 100. Similarly, a second movement signal causes the actuator 1205 to rotate a lead screw 1200 counterclockwise, which moves the fifth wheel connector 1150 along the guiding system 1105 in a second direction relative to the semi-tractor 100, with the second direction opposite to the first direction. As described above, the fifth wheel connector 1105 in this embodiment may include a rollover prevention 200 with separable fasteners 315 or a fixed fifth wheel connector that does not necessarily include separable fasteners 315.

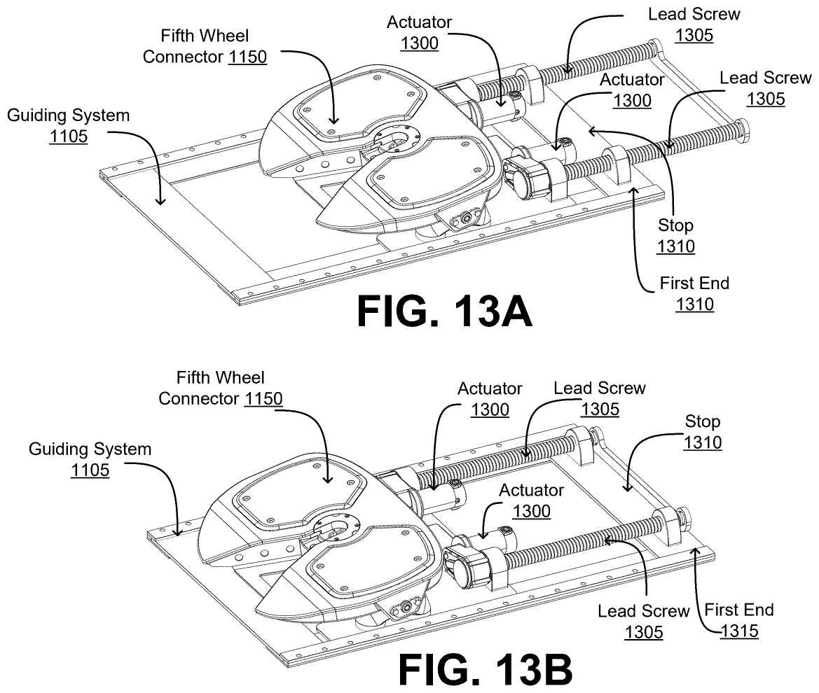

FIGS. 13A and 13B are perspective views of another embodiment of a repositionable fifth wheel connector 1150. In the example of FIGS. 13A and 13B, the fifth wheel connector 1150 is coupled to a guiding system 1105. For example, a bottom plate of the fifth wheel connector 1150 is coupled to the guiding system 1105. The guiding system 1105 is configured to be coupled to a surface of a semi-tractor 100.

The guiding system 1105 includes one or more actuators 1300 coupled to one or more lead screws 1305. In various embodiments, the lead screws 1305 are inserted through threaded holes in a stop 1310 positioned at a first end 1315 of the guiding system 1105. The actuator 1300 comprises an electric motor or a hydraulic motor that receives one or more movement signals from the controller 400 in various embodiments. Each lead screw 1305 may be coupled to a corresponding discrete actuator 1300 in some embodiments, while in other embodiments a common actuator 1300 is coupled to each lead screw 1305. In the embodiment shown by FIG. 13A, a lead screw 1305 is coupled to a portion of the fifth wheel connector 1150 at a first end. For example, a first end of a lead screw 1305 is coupled to a portion of a bottom plate 210 of the fifth wheel connector 1150.

In response to a movement signal, the actuator 1300 rotates the lead screw 1305 to move the fifth wheel connector 1150 along the guiding system 1105 relative to the stop 1310. In the example of FIG. 13A, in response to a first movement signal, the actuator 1300 actuator 1300 rotates a lead screw 1305 in a first direction (e.g., counterclockwise) to move the fifth wheel connector 1150 in a first direction relative to the stop 1310, such as towards the stop 1310 in the example of FIG. 13A. Similarly, FIG. 13B shows the actuator 1300 rotating a lead screw 1305 in a second direction (e.g., clockwise) in response to a second movement signal. In response to the lead screw 1305 rotating in the second direction, the fifth wheel connector 1150 moves in a second direction relative to the stop 1310, such as away from the stop 1310 in the example of FIG. 13B. In the example of FIGS. 13A and 13B, the lead screws 1305 do not move underneath the fifth wheel connector 1150, reducing an amount of space occupied by the guiding system 1105. Further, FIGS. 13A and 13B show the stop 1310 and the first end 1315 of the guiding system 1105 opposite to the a horseshoe-shaped opening of the fifth wheel connector 1150 through which a kingpin protruding from a bottom front surface of a semi-trailer, preventing the actuator 1300 or a lead screw 1305 from being contacted when a semi-trailer is coupled to the fifth wheel connector 1150.

In FIGS. 11-13B the illustrated fifth wheel connector 1150 may include a rollover prevention device 200 that can be repositioned along the guiding system 1105, or may comprise a fifth wheel 105 without separable fasteners 315. These embodiments allow a fifth wheel connector 1150 with or without separable fasteners to be repositioned relative to a semi-tractor 100 in response to control signals from a controller 400, as further described above. For example, a fifth wheel connector 1150 coupled to the guiding system 1105 is repositioned along the guiding system in response to one or more movement signals from a controller 400 determined based on a load on an axle of a semi-tractor 100 coupled to the fifth wheel connector 1150, as further described above. As another example, a fifth wheel connector 1150 coupled to the guiding system 1105 is repositioned along the guiding system in response to one or more movement signals from a controller 400 determined based on a height of a center of gravity of a semi-trailer coupled to the fifth wheel 105, as further described above.

FIG. 14 is a flowchart of an example embodiment of a method for determining whether to transmit a control signal to frangible fasteners of a rollover prevention device 200. In various embodiments, steps of the method are performed by the controller 400 of the rollover prevention device 200. Further, in various embodiments, the method may include different or additional steps than those described in conjunction with FIG. 14. Additionally, in some embodiments, the steps of the method may be performed in a different order than the order described in conjunction with FIG. 14.

The controller 400 determines 1405 a roll angle of the rollover prevention device 200, as further described above in conjunction with FIG. 5. In various embodiments, the controller 400 includes an inertial measurement unit including one or more sensors that capture a roll angle of the rollover prevention device 200 and the controller 400 receives the roll angle. As another example, the rollover prevention device 200 determines 1405 the roll angle based on data captured by one or more of the sensors. Example sensors include a three-axis accelerometer or a gyroscope, although other sensors or combinations of sensors may be used. As further described above in conjunction with FIG. 5, in some embodiments, the one or more sensors are included in the controller, while in other embodiments the sensors are coupled to the controller 400. The roll angle is measured relative to a horizontal axis orthogonal to the sensor, providing a measure of a deviation of the position of the sensor (e.g., at the rollover prevention device 200) from the horizontal axis.

Additionally, the controller 400 determines 1410 a roll rate of the rollover prevention device 200. One or more of the sensors capturing data used to determine 1205 the roll angle also capture data for determining 1410 the roll rate or the rollover prevention device 200. The roll rate indicates a rate at which the roll angle of the rollover prevention device 200 relative to a horizontal axis orthogonal to the sensor (e.g., the IMU) changes over time. In various embodiments, the controller 400 determines 100 the roll rate in degrees per second or in radians per second.

The controller 400 determines 1415 whether the roll angle and/or the roll rate satisfy a rollover condition. In an embodiment, the controller 400 maintains a table that maps different combinations of roll angles and roll rates to an output indicating whether a rollover condition is met. The rollover combination may be based on the roll angle alone exceed a threshold, the roll rate alone exceeding a threshold, or a combination of roll angle and roll rate meeting a rollover condition. As further described above in conjunction with FIG. 5, in various embodiments, one or more rollover conditions may be further based on a height of a center of gravity that the controller 400 determines for a semi-trailer coupled to the rollover prevention device 200, so the controller 400 may dynamically adjust one or more rollover conditions based on characteristics of the semi-trailer.

In response to determining 1415 the roll angle and/or the roll rate satisfies a rollover condition, the controller 400 transmits 1220 a control signal to one or more separation fasteners 315 (e.g., frangible bolts) included in the rollover prevention device 200. The frangible fasteners couple the top plate 205 of the rollover prevention device 200 to the bottom plate 210 of the rollover prevention device 200. In response to receiving the control signal, one or more explosive charges in a frangible bolt detonate, separating the frangible fastener into multiple pieces (or a separation fastener 315 otherwise separates into multiple pieces). Separation of the frangible fastener allows a top plate 205 of the rollover prevention device 200 to detach from the bottom plate 210 of the rollover prevention device 200, as further described above in conjunction with FIGS. 3 and 7.

As further described above in conjunction with FIGS. 3 and 10, in various embodiments the top plate 205 of the rollover prevention device 200 is coupled to the bottom plate 210 of the rollover prevention device 200 through one or more secondary securing mechanisms. Examples of secondary securing mechanisms include the mounting cones 310 and corresponding cavities of the pillow block in FIGS. 2 and 3 or the hinge 1000 coupling a pillow block top component 900 to a pillow block bottom component 905, as further described above in conjunction with FIGS. 9 and 10. When the frangible fasteners are detonated in the absence of a rollover condition (e.g., detonated due to a faulty sensor or controller detection), the secondary securing mechanisms may operate to maintain coupling the top plate 205 of the rollover prevention device 200 to the bottom plate 210 of the rollover prevention device 200 unless the top plate 205 rotates relative to the bottom plate 210 as during a rollover. For example, the secondary securing mechanisms couple the top plate 205 to the bottom plate 210 until one or more portions of the top plate 205 are raised above corresponding portions of the bottom plate 210, as further described above in conjunction with FIG. 7.

Under normal operation, in response to determining 1415 the determined roll angle and the determined roll rate do not satisfy at least one rollover condition, the controller 400 does not cause separation of the separable fastener 315. The controller 400 continues to monitor the roll angle and roll rate, as further described above continuously or on a periodical interval.

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope is not limited by this detailed description, but rather by any claims that issue on an application based hereon. Accordingly, the disclosure of the embodiments is intended to be illustrative, but not limiting, of the scope of the invention.

1. A rollover prevention device comprising:
a top plate;
a bottom plate coupled to the top plate by one or more separation fasteners; and
a controller coupled to one or more sensors, the controller configured to:
determine a roll angle of the rollover prevention device based on data from the one or more sensors;
determine a roll rate of the rollover prevention device based on data from the one or more sensors; and
transmit a control signal to each of the separable fasteners in response to determining at least one of the roll angle or the roll rate satisfies at least one rollover condition, the control signal separating one or more separation fasteners to enable the top plate to detach from the bottom plate.

2. The rollover prevention device of claim 1, wherein the one or more separation fasteners comprise frangible fasteners including one or more explosive charges, and wherein the one or more explosive charges in a frangible fastener detonate in response to the control signal to enable the top plate to detach from the bottom plate.

3. The rollover prevention device of claim 1, further comprising:
one or more secondary securing mechanisms coupling the bottom plate to the top plate, the one or more secondary securing mechanisms coupling the top plate to the bottom plate after the one or more separation fasteners separate until a portion of the top plate has a specific orientation relative to a portion of the bottom plate.

4. The rollover prevention device of claim 3, wherein a secondary securing mechanism comprises a pillow block to which the top plate is coupled, the pillow block including a cavity into which a mounting cone coupled to the bottom plate is inserted.

5. The rollover prevention device of claim 4, wherein a separation fastener is inserted through the mounting cone into the cavity of the pillow block.

6. The rollover prevention device of claim 3, wherein a secondary securing mechanism comprises a pillow block having a pillow block top component coupled to the top plate and a pillow block bottom component coupled to the bottom plate, the pillow block top component coupled to the pillow block bottom component by a hinge.

7. The rollover prevention device of claim 6, wherein a separation fastener is inserted horizontally through the pillow block through a portion of the pillow block top component and the pillow block bottom component.

8. The rollover prevention device of claim 1, wherein determining the roll angle or the roll rate satisfies at least one rollover condition comprises:
determining the roll angle is within a threshold amount of a threshold roll angle.

9. The rollover prevention device of claim 1, wherein determining the roll angle or the roll rate satisfies at least one rollover condition comprises:
determining the roll angle is greater than a threshold amount of a threshold roll angle and the roll rate is greater than a threshold roll rate.

10. The rollover prevention device of claim 9, wherein the threshold roll rate is based on the roll angle.

11. The rollover prevention device of claim 1, wherein the top plate is configured to be coupled to a semi-trailer and the bottom plate is configured to be coupled to a semi-tractor.

12. The rollover prevention device of claim 11, wherein the controller is further configured to determine a height of a center of gravity of the semi-trailer based on data captured by one or more sensors coupled to the controller.

13. The rollover prevention device of claim 12, wherein one or more of the rollover conditions are based at least in part on the height of the center of gravity of the semi-trailer.

14. The rollover prevention device of claim 13, wherein the controller decreases a threshold roll angle in response to determining the height of the center of gravity of the semi-trailer is greater than a threshold value.

15. The rollover prevention device of claim 1, further comprising:
a guiding system couple to the bottom plate; and
an actuator coupled to the bottom plate and to the guiding system, the actuator configured to receive one or more movement signals from the controller and to move the bottom plate along the guiding system.

16. A rollover prevention device comprising:
a top plate;
a bottom plate coupled to the top plate by one or more separation fasteners;
a guiding system couple to the bottom plate;
an actuator coupled to the bottom plate and to the guiding system, the actuator configured move the bottom plate along the guiding system in response to receiving a movement signal; and
a controller coupled to one or more sensors, the controller configured to:
determine a roll angle of the rollover prevention device based on data from the one or more sensors;
determine a roll rate of the rollover prevention device based on data from the one or more sensors;
transmit a control signal to each of the one or more separation fasteners in response to determining at least one of the roll angle or the roll rate satisfies at least one rollover condition, the control signal separating one or more separation fasteners to enable the top plate to detach from the bottom plate; and
generate a movement signal for the actuator based on data captured by the one or more sensors.

17. The rollover prevention device of claim 16, wherein the one or more separation fasteners comprise frangible fasteners including one or more explosive charges, and wherein the one or more explosive charges in a frangible fastener detonate in response to the control signal to enable the top plate to detach from the bottom plate.

18. The rollover prevention device of claim 16, wherein the top plate is configured to be coupled to a semi-trailer and the guiding system is configured to be coupled to a semi-tractor.

19. The rollover prevention device of claim 18, wherein the controller is further configured to:
determine a speed of the semi-tractor;
determine a load on an axle of the semi-trailer and a load on an axle of the semi-tractor when a suspension of the semi-trailer is in a position determined by the controller;
determine an updated position of the suspension of the semi-trailer based on the speed of the semi-tractor;
determine whether a load on the axle of the semi-tractor when the suspension of the semi-trailer is in an updated position equals or exceeds a threshold value; and
generate a movement signal for the actuator to move the bottom plate along the guiding system so the suspension of the semi-trailer is in the updated position in response to determining the load on the axle of the semi-tractor when the suspension of the semi-trailer is in an updated position is less than the threshold value.

20. The rollover prevention device of claim 19, wherein the controller is further configured to:
determine an alternative position of the suspension of the semi-trailer based on the speed of the semi-tractor in response to determining the load on the axle of the semi-tractor when the suspension of the semi-trailer is in an updated position equals or exceeds a threshold value.

21-25. (canceled)
